(19) United States
(12) Patent Application Publication
(10) Pub. No.: US 2006/0073455 A1
(43) Pub. Date: Apr. 6, 2006

(54) Virtual reality based prototyping system for medical devices

(75) Inventors: Hans Buyl, Geraardsbergen (BG); Hendrik Lambert, Deinze (BE); Douglas J. Lang, Arden Hills, MN (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(73) Assignee: Cardiac Pacemakers, Inc.

(21) Appl. No.: 10/954,448

(22) Filed: Sep. 30, 2004

(51) Int. Cl. G09B 23/28

(52) U.S. Cl. 434/262

(57) ABSTRACT

A system comprising a computer and a software module residing in computer memory, where the software module is operable to provide a virtual model of a medical device and to simulate a medical procedure involving the virtual model of the medical device. The virtual model of the medical device includes medical device design parameters. The system also includes a computer interface operable to change design parameters of the virtual model of the medical device in response to simulation of the virtual model in the medical procedure.

### TECHNICAL FIELD

The field generally relates to medical devices including implantable electrical leads and vascular intervention devices and, in particular, but not by way of limitation, to a system and method for prototyping the medical devices using a virtual reality prototyping system.

### BACKGROUND

Medical devices include those devices that have cardiac, vascular, or extra-vascular applications. Devices that have vascular applications include electrical leads that are to be used with implantable medical devices. These implantable medical devices (IMDs) include cardiac rhythm management (CRM) devices such as pulse generators. The electrical leads are connected to the CRM device for communication with sense amplifiers to monitor electrical heart activity within a patient. Implanting an electrical lead often requires placement using extra-vascular medical devices such as guide wires and guide catheters. Other devices with extra-vascular applications include catheters and angioplasty devices. Other implantable medical devices include vascular intervention devices such as stents.

The vascular procedures that use these medical devices require a great degree of skill on the part of a physician. Systems to assist in the training of physicians have been developed. These systems simulate a vascular access procedure by providing a virtual reality environment for the physician. The virtual reality environment can be, for example, a fluoroscopic image of part of a patient's body. The systems also include an interface device, or vascular intervention device, in which the medical device is inserted. The physician inserts the medical device into the vascular intervention device to simulate a vascular access procedure. The vascular intervention device tracks the movement of the medical device into a virtual reality vascular system and displays the simulated progress of the medical device on the fluoroscopic image. The vascular intervention device provides tactile feedback to the physician's hands to simulate the progress of the medical device through a patient's body. In this way the virtual reality training system simulates the medical device used in an actual procedure.

Optimizing the design of these medical devices often includes an extensive design and testing phase requiring multiple design iterations to arrive at a good result. The design iterations may involve building prototypes of the devices. The building of prototypes involves additional cycles of design and development. Physicians then are trained on the finished product, sometimes by using the virtual reality training systems. It is desirable to bring finished products into the market more quickly by shortening the design and testing process of the medical devices.

### SUMMARY

Systems and methods are provided for rapid prototyping of medical devices. In one system example, the system comprises a computer and a software module residing in computer memory, where the software module is operable to provide a virtual model of a medical device and to simulate a medical procedure involving the virtual model of the medical device. The virtual model of the medical device includes medical device design parameters. The system also includes a computer interface operable to change design parameters of the virtual model of the medical device in response to simulation of the virtual model in the medical procedure.

In one method example, the method comprises creating a virtual model prototype of a medical device, simulating a vascular intervention procedure of the medical device virtual model with a virtual reality system, and changing design parameters of the medical device in response to the simulating.

This summary is intended to provide an overview of the subject matter of the present patent application. It is not intended to provide an exclusive or exhaustive explanation of the invention. The detailed description is included to provide further information about the subject matter of the present patent application.

### BRIEF DESCRIPTION OF THE DRAWINGS

FIG. 1 is a block diagram of a system that includes a virtual model prototype for a medical device.

FIG. 2 shows an embodiment of a system that uses a vascular intervention device.

FIG. 3 illustrates an embodiment of a method of prototyping medical devices.

### DETAILED DESCRIPTION

In the following detailed description, reference is made to the accompanying drawings which form a part hereof, and specific embodiments in which the invention may be practiced are shown by way of illustration. It is to be understood that other embodiments may be used and structural or logical changes may be made without departing from the scope of the present invention.

Systems and methods for rapid prototyping of medical devices are discussed herein. These medical devices for prototyping include, without limitation, implantable electrical leads for pacemakers, cardioverter defibrillators, and resynchronization devices. They also include angioplasty devices such as angioplasty balloons and stents. The devices for prototyping further include vascular intervention devices used in placing or implanting the devices such as guide wires, guiding catheters, stylets and the like.

To shorten the design process for developing a medical device, a virtual model of the medical device is created before a physical prototype is made. The virtual model includes design parameters that define the mechanical characteristics of the medical device. If the medical device is an implantable electrical lead, the virtual model of the lead includes design parameters calculated along the length of the lead. The design parameters include parameters related to ductility, bend, stiffness, elasticity, conformability, flexibility, support, pull strength and the like.

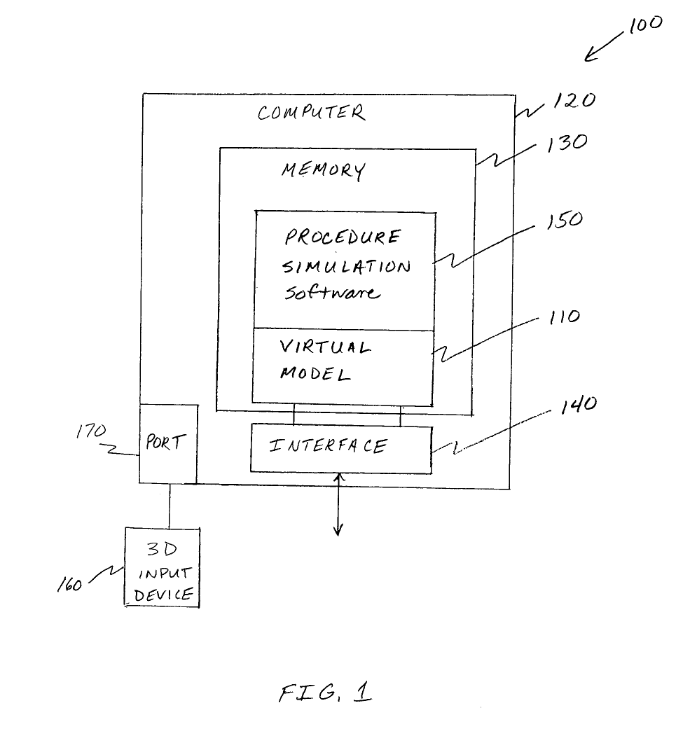

FIG. 1 is a block diagram of a system 100 that includes a virtual model prototype 110 for a medical device. The system includes a computer 120 and memory 130 to store the virtual model 110. The system 100 also includes an interface 140 for changing the design parameters and software 150 for virtual reality simulation of a vascular intervention procedure. The simulation software 150 simulates the progress of the virtual model 110 through a virtual reality representation of human anatomy, such as a vascular system of a patient. The simulation software 150 calculates the forces the medical device would encounter in the virtual reality space and then simulates the resulting movement of the virtual model of the device in response to the calculated forces.

The simulation software 150 includes spatial data related to an implant path for the medical device. In one embodiment, the spatial data is related to a vascular system of a patient. The spatial data includes representations of solid objects such as vessel walls that the virtual model cannot move through, as well as openings that the virtual model can move through. In one embodiment, the virtual reality space is represented in virtual reality modeling language (VRML). In another embodiment, the virtual reality space is represented using a Bubble Worlds application.

A designer using the system 100 is able to enter changes to the design parameters of the virtual reality model through the parameter interface 140. This allows the designer to readily see and feel the effect a change in the design will have on the medical device in its environment without the need for building physical prototypes of the device. In one embodiment, the interface 140 includes a computer keyboard for entering the design parameters. In another embodiment the interface 140 includes a mouse for navigating menus for changing or selecting the design parameters. In yet another embodiment, the interface 140 includes menus for selecting or entering design parameters that are navigated using a graphical user interface (GUI). In yet another embodiment, the interface is operable to accept changes in the design parameters from a machine accessible medium such as a diskette and the like.

The virtual models 110 can vary in the amount of detail or granularity they include in the design parameters along the medical device. For example, the virtual model 10 may include design parameters only where the medical device undergoes a significant change such as a change in diameter, or the virtual model 110 may include design parameters for as many points along the device as are practical for a given computer system, such as for example, every millimeter of the lead. In another example, the virtual model includes only one design parameter evaluated at many points along the device. In this way, a simulation calculating the response of the medical device to forces it encounters during a procedure can be accommodated on computer systems of varying amounts of processing power without slowing down computer interaction with a user. In one embodiment the virtual model 110 is created by inputting all of the design parameters into the system 100. In another embodiment, a virtual model for an existing medical device design is pre-loaded, and only the design parameters that change for the new device design are input to the system 100. In yet another embodiment, the design changes are made interactively with the simulation and the simulated behavior of the device changes as the new parameters are entered. In an option, the system 100 is further adapted to compute how a change in a first parameter affects the other parameters. Such an effect may be on a first order or second order. For example, a change in a first parameter may result in a change in a second parameter but not in a third parameter. The change in the first parameter may only result in a change in a fourth parameter if the change in the first parameter is of a certain amount or magnitude. In an option, the system 100 is further adapted to provide limits on the values of at least one of the parameters. The limits are lower and upper boundaries for values of a parameter. Such limits are determined by limitations of the environment in which the virtually modeled medical device is used in an option. The limits are determined by manufacturing limitations in a further option. The system 100 will warn the designer that the limits are being exceeded. In this case, the system will allow the option of proceeding with a virtual modeling of the medical device after the warning is issued. Such limits inform a designer of acceptable operational parameters.

To simulate the movement of the virtual model 110 through the virtual reality space of human anatomy, the system includes a three dimensional (3D) input device 160 in communication with a computer port 170. The 3D input device 160 allows the virtual model 110 to be manipulated by rotating, pushing or pulling in 3D virtual space by providing information related to the virtual model's position and orientation. In one embodiment, the 3D input device 160 is a glove.

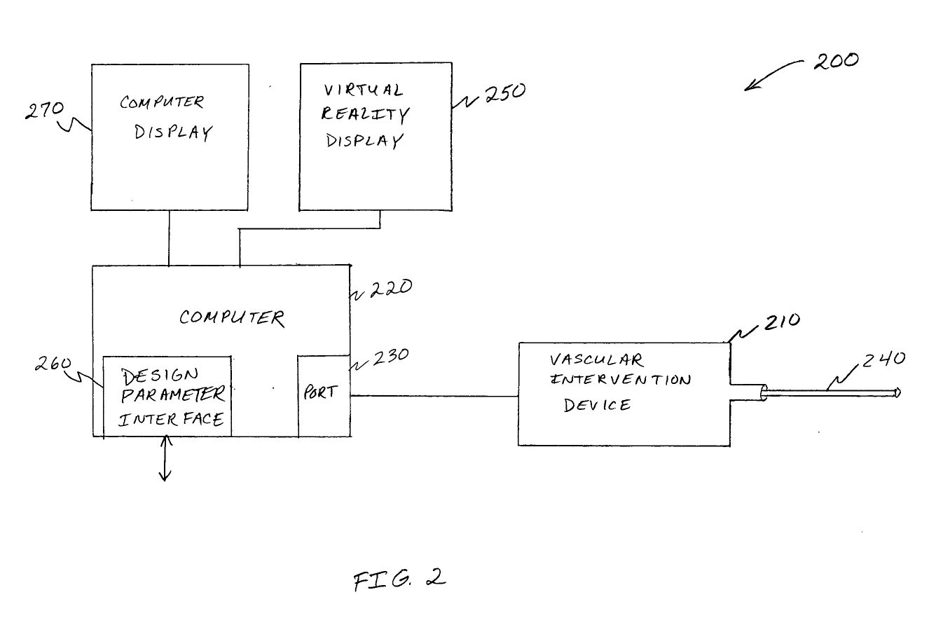

FIG. 2 shows an embodiment of a system 200 that uses a vascular intervention device 210 as the 3D input device. The intervention device 210 is in communication with a computer 220 through computer port 230. In one embodiment, the computer 220 is in direct communication with the intervention device 210. In another embodiment, the communication is over a computer network. In yet another embodiment, the computer 220 communicates with the intervention device 210 over the internet. The vascular intervention device 210 includes an opening to accept a mock medical device 240. The intervention device 210 tracks movement of the mock device 240 and includes internal mechanisms (not shown) to provide tactile feedback on the mock device 240. For example, the intervention device 210 provides resistance to a user placing a torque on the mock device 240, or the intervention device refuses to allow advancement of the medical device because it has encountered a solid object in virtual reality space. To test a virtual model of the medical device design, the mock device 240 is inserted into the intervention device 210 to simulate a vascular intervention procedure. The computer 220 includes simulation software to simulate the interaction of the virtual model with a virtual reality representation of a vascular system of a patient. The interaction of the virtual model with the virtual reality environment is shown on virtual reality display 250. In one embodiment, the display 250 is a fluoroscopic virtual reality image. A design parameter interface 260 is used to update design parameters for a virtual model. The computer display 270 is useful to run the system and for prompting a designer to enter new design parameters.

The intervention device 210 provides positional information on the progress of the mock medical device to the computer 220. The computer 220 uses the simulation software to calculate the resulting forces on the virtual model and displays the resulting position on the virtual reality display 250. The computer 220 also provides control signals to the vascular intervention device 210. The control signals prompt the intervention device 210 to provide tactile feedback on the mock device 240. The tactile feedback on the mock device 240 gives the designer the feel of the new device design. This is useful for example in assisting the designer to assess how a proposed medical device design conforms to irregular vein paths while remaining sufficiently stiff for pushing.

In response to the simulation, the designer changes design parameters of the virtual model by using the design parameter interface 250. Changing the design parameters includes changes that involve loading a new model or only modifying one design parameter of the currently loaded virtual model. Changing the design parameters of the medical device in turn causes the computer simulation to alter the performance of the virtual device. This will result in possible changes in movement of the virtual device in the virtual environment. Changes in the design parameters also cause the computer 220 to change the control signals provided to the intervention device 210 resulting in changes in the tactile feedback provided to the user.

In one embodiment, the mock device includes a guide catheter, a guide wire and an electrical lead. The simulated procedure then includes simulating a vascular intervention with the guide catheter, inserting a guide wire to a desired placement in the virtual reality vascular system, and inserting an electrical lead over the guide wire and placing an end electrode of the lead. In another embodiment, the simulation involves an actual device interacting with the mock devices. For example, the simulation may involve only the guide wire and lead mock devices, and the designer adjusts an actual catheter so the intervention device may receive the guide wire and lead, such as by bending the catheter.

In response to the simulated procedure, the designer changes design parameters related to one or a combination of the guide catheter, guide wire and electrical lead. For example, the designer may adjust the surface texture or friction coefficient on an insulating sleeve or other lumen of the medical device. The designer may change the diameter or material of the guide wire to make it more resistant to kinking. The designer may upload a new virtual model that uses a different design such as a model that includes an electrical lead body that is a twisted pair instead of a lead body that is a helical winding.

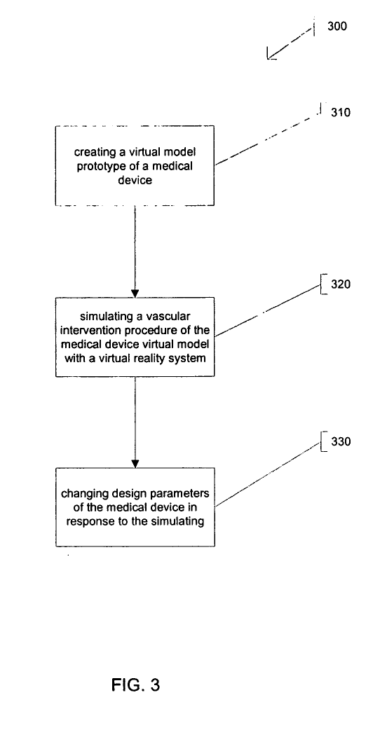

FIG. 3 illustrates an embodiment of a method 300 of prototyping medical devices. At 310 a virtual model prototype of a medical device is created. At 320, a vascular intervention procedure of the medical device virtual model is simulated with a virtual reality system. At 330, design parameters of the medical device are changed in response to the simulating. In one embodiment the parameters are loaded by loading a new virtual model. In another embodiment, a virtual model for an existing medical device design is pre-loaded, and only the design parameters that change for the new device design are entered. In yet another embodiment, the design changes are made interactively with the simulation and the simulated behavior of the device changes as the new parameters are entered.

Once a designer is satisfied with the performance of the virtual design, physical prototypes of the design are made. Because these prototypes have been simulated in a virtual space representing the environment for the device, the first physical prototype is closer to an optimum result than a prototype not developed using virtual simulation, thereby saving development time and cost.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations, or variations, or combinations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system comprising:
a computer;
a software module residing in computer memory, the module operable to provide a virtual model of a medical device and to simulate a medical procedure involving the virtual model of the medical device, wherein the virtual model of the medical device includes alterable medical device design parameters; and
a computer interface operable to change design parameters of the virtual model of the medical device in response to simulation of the virtual model in the medical procedure.

2. The system of claim 1, wherein the computer interface is operable to read medical device design parameters from a machine accessible medium.

3. The system of claim 1, wherein the computer interface is operable to accept changes to design parameters entered manually.

4. The system of claim 1, wherein the medical procedure is a vascular intervention procedure, and wherein the system further includes a virtual vascular intervention device in communication with the computer, the vascular intervention device to simulate a vascular intervention procedure.

5. The system of claim 4, wherein the computer interface is operable to provide vascular intervention simulation data to a system user.

6. The system of claim 4, wherein the virtual vascular intervention device includes a mock physical representation of the medical device, wherein the vascular intervention device tracks the advancement of the mock medical device, wherein the virtual vascular intervention device applies feedback force on the mock medical device to simulate implant of the virtual medical device, and wherein the feedback force is adjustable to correlate with device design parameters.

7. The system of claim 4, wherein the system further includes a display to provide virtual images of the vascular intervention procedure, the virtual images representing an interaction of the medical device with a virtual reality space, the interaction based at least in part on the device design parameters.

8. The system of claim 4, wherein the virtual vascular intervention device is operable to communicate with the computer over a computer network.

9. The system of claim 1, wherein the medical device is an implantable electrical lead for a cardiac rhythm management device.

10. The system of claim 1, wherein the medical device includes a catheter.

11. The system of claim 1, wherein the implantable medical device includes a vascular intervention stent.

12. A method comprising:
creating a virtual model prototype of a medical device;
simulating a vascular intervention procedure of the medical device virtual model with a virtual reality system; and
changing design parameters of the medical device in response to the simulating.

13. The method of claim 12, wherein creating the virtual model prototype of the medical device includes characterizing at least one design parameter at a physical location of the medical device.

14. The method of claim 12, wherein creating the virtual model prototype of the medical device includes characterizing at least one design parameter at all physical locations of the medical device.

15. The method of claim 12, wherein simulating a vascular intervention procedure of the medical device with a virtual reality system includes simulating interactions of the device with a virtual reality space representative of a human anatomy, the interactions based at least in part on the device design parameters.

16. The method of claim 12, wherein the design changes are made interactively with the simulating and a simulated behavior of the medical device changes as the design parameters are entered.

17. The method of claim 12, wherein creating a virtual model prototype of a medical device includes creating a virtual model of an implantable electrical lead for a cardiac rhythm management system.

18. The method of claim 17, wherein simulating a vascular intervention procedure of the lead with a virtual reality system includes:
generating spatial data related to an implant path for the lead;
simulating movement of the lead through the spatial data; and
simulating changes in movement of the lead as the lead advances through the spatial data; and
changing lead design parameters in response to the simulated movement of the lead.

19. The method of claim 12, wherein prototyping a medical device includes prototyping one of a catheter and a vascular intervention stent.

20. The method of claim 12, wherein changing design parameters includes loading a different complete virtual model for the medical device.

21. The method of claim 12, wherein changing design parameters includes interactively changing design parameters for the medical device.

22. A machine accessible medium containing machine accessible instructions to perform the method of claim 12.

23. A software module operable to:
provide a virtual model of a medical device, the virtual model including design parameters of the medical device;
simulate an interaction of the virtual model and a virtual reality space representative of the human anatomy; and
accept changes in design parameters for the virtual model.

24. The software module of claim 23, wherein the virtual model includes one of an implantable electrical lead, a catheter, and a vascular intervention stent.

25. The software module of claim 23, wherein operable to accept changes in design parameters includes operable to change at least one design parameter for at least one physical location on the medical device.

26. The software module of claim 23, wherein operable to accept changes in design parameters includes operable to accept a complete set of design parameters.

27. The software module of claim 23 further operable to receive tracking information from a virtual vascular intervention device, the tracking information related to movement of a mock medical device.
